(19) United States
(12) Patent Application Publication
(10) Pub. No.: US 2006/0153141 A1
(43) Pub. Date: Jul. 13, 2006

(54) Method and apparatus for acquiring a carrier frequency in a CDMA communication system

(76) Inventor: Asao Hirano, Yokohoma (JP)

Correspondence Address: MOTOROLA INC, 600 NORTH US HIGHWAY 45, ROOM AS437, LIBERTYVILLE, IL, 60048-5343, US

(21) Appl. No.: 11/035,192

(22) Filed: Jan. 13, 2005

(51) Int. Cl. H04B 7/216

(52) U.S. Cl. 370/335; 370/342; 370/441

(57) ABSTRACT

A wideband CDMA handset has a receiver that simplifies initial sequence acquisition. The receiver searches and assigns a base station carrier frequency located within a predetermined frequency band by scanning at predetermined intervals within the frequency band (38), such as every 5 MHz in a 60 MHz band. The receiver measures the received signal strength at each predetermined interval (40) and generates a received strength signal indication (RSSI) at each predetermined interval. An RSSI ratio is then calculated (42) for adjacent scanned intervals and the calculated ratios are compared (46) to a predetermined RSSI value. If one of the ratios is greater than the predetermined RSSI value, a center frequency thereof is estimated (50) and assigned as the frequency for communications with the base station.

### BACKGROUND OF THE INVENTION

The present invention relates generally to communications systems, and more particularly, to a method and apparatus for acquiring a carrier frequency in a code division multiple access (CDMA) communications system.

Code division multiple access (CDMA) has recently been used in the United States for digital cellular telephone systems. In other regions such as Japan and Europe, a variation of CDMA known as wideband CDMA (WCDMA) has been used. WCDMA allows very high-speed multimedia services such as voice, Internet access, and videoconferencing at access speeds up to 2 Mbps in the local area and 384 kbps wide area access. CDMA uses a spread spectrum modulation technique, in which the signal energy of each channel is spread over a wide frequency band, and in which multiple channels each corresponding to a different system user occupy the same frequency band. CDMA offers the advantage of efficient use of the available frequency spectrum, but at the cost of being computationally intensive.

In order to demodulate a received signal, a mobile CDMA receiver must identify and synchronize to a local base station in a timely manner. This process is known as acquisition. During acquisition, the mobile receiver determines the spreading code sequence and spreading code phase of a suitable base station. To make it easier for the mobile receiver to acquire the spreading code sequence and phase of the base station, the base station transmits several pilot signals. The pilot signals are helpers that allow the mobile receiver to more easily determine the spreading code sequence and spreading code phase. In order to synchronize to the base station, the mobile station selects a possible synchronization point and tests whether the signal energy using this synchronization point exceeds a threshold. This process is called hypothesis testing. The mobile receiver must perform hypothesis testing using different possible synchronization points until it finds one with a very high probability of being correct. The mobile receiver also continually searches for other base stations as call handoff candidates.

In the present third generation environment (3GPP), when a handset is turned on, it is necessary to assign a frequency carrier from a total of about 300 of a 200 kHz raster in a 60 MHz frequency band. Each frequency carrier is set up asynchronously between various service providers in order to allow for international roaming. Thus, at the time of initial power on, the handset must check and detect all of the channel frequencies and assign a frequency, usually based on a received signal strength indication (RSSI) measurement.

Thus acquisition in a mobile CDMA receiver requires many computations. These computations tend to decrease battery life. It would be advantageous to have a CDMA receiver that can quickly search and acquire a base station and consume very little power.

### BRIEF DESCRIPTION OF THE DRAWINGS

The following detailed description of a preferred embodiment of the invention will be better understood when read in conjunction with the appended drawings. For the purpose of illustrating the invention, there is shown in the drawings an embodiment that is presently preferred. It should be understood, however, that the invention is not limited to the precise arrangement and instrumentalities shown. In the drawings:

FIG. 1 is a flow chart of a method for searching and acquiring a frequency carrier in accordance with the present invention;

FIG. 2 is a schematic block diagram of a portion of a wireless communication device that searches and acquires a frequency carrier in accordance with the method shown in FIG. 1;

FIGS. 3A-3C are graphs for illustrating a first example of the search and acquisition method of the present invention;

FIGS. 4A-4C are graphs for illustrating a second example of the search and acquisition method of the present invention; and

FIGS. 5A-5C are graphs for illustrating a third example of the search and acquisition method of the present ivention.

### DETAILED DESCRIPTION OF A PREFERRED EMBODIMENT

The detailed description set forth below in connection with the appended drawings is intended as a description of the presently preferred embodiment of the invention, and is not intended to represent the only form in which the present invention may be practiced. It is to be understood that the same or equivalent functions may be accomplished by different embodiments that are intended to be encompassed within the spirit and scope of the invention. Further, although the invention is illustrated in a WCDMA system, it may be applied to other systems, such as a MC-CDMA system. In the drawings, like numerals are used to indicate like elements throughout.

In accordance with the present invention, a wireless communication device, i.e., a cell phone, searches for and acquires a carrier frequency by presuming a particular carrier frequency, without searching all channels, so that the time required to search and acquire a channel and current consumed by the process are reduced.

In one embodiment of the invention, a method of searching for and assigning a base station carrier frequency to a wireless device, wherein the base station carrier frequency is located within a predetermined frequency band, includes the steps of scanning the predetermined frequency band at predetermined intervals, each predetermined interval having a received signal strength, and measuring the received signal strength at each predetermined interval and generating a received strength signal indication (RSSI) at each predetermined interval. Then an RSSI ratio is calculated for adjacent scanned intervals. The calculated RSSI ratios are compared to a predetermined RSSI value and a center frequency of at least one of the calculated RSSI ratios that is greater than the predetermined RSSI value is estimated. The estimated center frequency is then assigned to the wireless device for communications with the base station. Thus, only a limited amount of scanning is required to detect a base station carrier frequency with a strong RSSI.

The scanning, measuring, calculating and comparing steps define a loop. In another embodiment, in the comparing step, if none of the calculated RSSI ratios exceed the predetermined RSSI value, then the loop steps are performed again, with the predetermined intervals of the scanning step being adjusted so that more frequencies within the predetermined frequency band are scanned. The loop can be performed a number of times until one of the calculated RSSI ratios exceeds the predetermined RSSI value. If the loop is performed a number of times and still none of the calculated RSSI ratios exceed the predetermined RSSI value, then the scanning step is performed again and all of the frequencies of the predetermined frequency band are scanned and the RSSI at each frequency is checked until a band having an RSSI exceeding the predetermined RSSI value is found.

In another embodiment, prior to the scanning step, the method determines whether base station carrier frequency data has been pre-set, including a pre-set frequency, in which case the signal strength of the pre-set frequency is measured.

In yet another embodiment, prior to the scanning step, the method determines if an alternative carrier frequency assignment routine has been pre-stored in the wireless device, and if so, the alternative routine is executed.

In a further embodiment, prior to scanning step, the method determines if the wireless device has been powered on in a W-CDMA environment, and if not, then all available frequencies in the environment are scanned to acquire and assign a base station frequency.

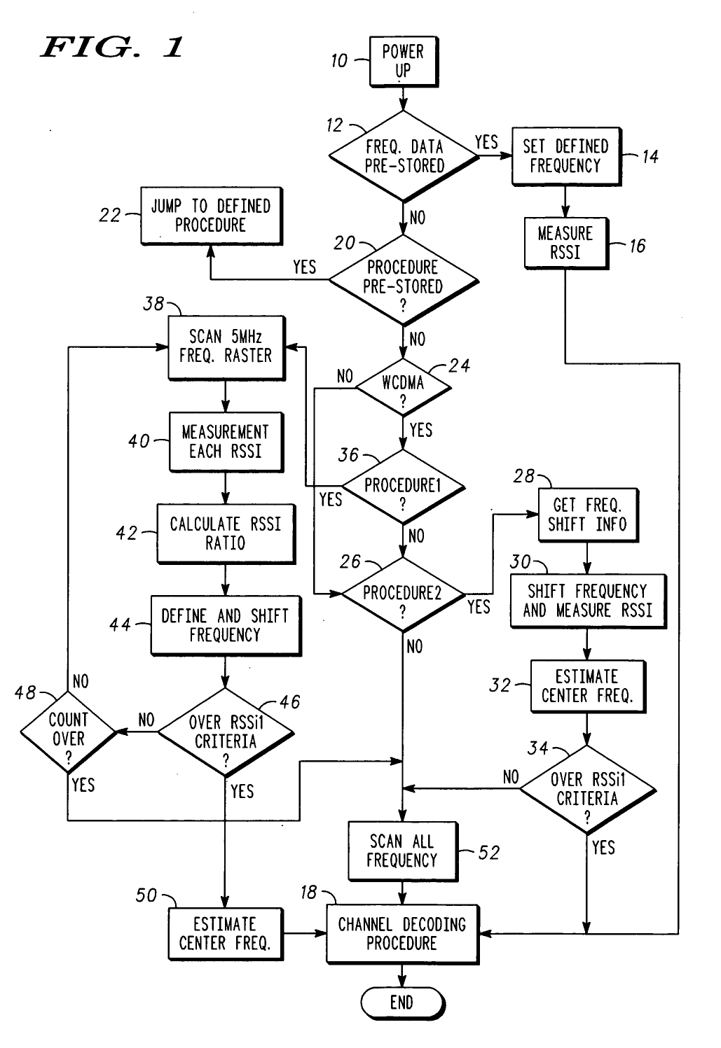

Referring now to FIG. 1, a flow chart of a method for searching and acquiring a frequency carrier in accordance with the present invention is shown. The method is optimized for a W-CDMA environment. However, as will be understood by those of skill in the art, the method may be used for other communication environments. The method begins when the communication device is powered on at block 10. The communications device may be a CDMA type device operating on a single band or a multi-band device. If the communications device is a W-CDMA device only, some of the steps may not be included in the software and/or hardware used to implement the method.

After the device is powered on, at step 12 the method checks to determine whether carrier data is pre-stored or pre-set in the device. That is, whether a pre-set frequency of a particular carrier or service provider has been pre-set. For example, the user may desire to only use specified carriers, which are known to operate at predetermined frequencies. In such case, a flag may be set in a register or memory location of the device and checked. If such flag is set (or clear using negative logic), then step 14 is executed, which sets-up the device to operate at the pre-stored frequencies. At step 16, the signal strength at the pre-stored frequency is measured and then at step 18, known channel decoding procedures are executed. In an exemplary embodiment, a soft decision Viterbi algorithm decoder is used. The resulting decoded information bits are passed to further circuitry, which typically includes a digital vocoder and serves as an interface with a speaker, microphone, and display screen to form a cellular handset. Measuring signal strength, calculating RSSI, and channel decoding are all well known in the art and further description of these steps is not necessary for a complete understanding of the invention.

If, at step 12, frequency data is not pre-set, then the method continues to step 20. At step 20, the method checks to determine whether an alternative carrier frequency assignment routine has been pre-stored in the wireless device and based on the results of the determining step, if an alternative routine has been pre-stored, the method jumps to step 22 to execute the pre-stored frequency assignment routine. A pre-stored frequency assignment routine, as indicated at step 22, might be desirable, for instance, to proceed directly to one of the below-described procedures at steps 28, 38, and 52. Otherwise, the method proceeds to step 24, where the device checks to determine whether it has been powered on in a W-CDMA environment, as opposed to, for instance, a CDMA-2000 type environment. This environment check is typically performed by checking information stored in the user SIM card. An alternative would be for such information to be stored in a device memory, such as a flash memory. If the environment is not a W-CDMA environment, then an alternative processing routine is performed beginning at step 26. It is noted that step 24 could be performed before step 20.

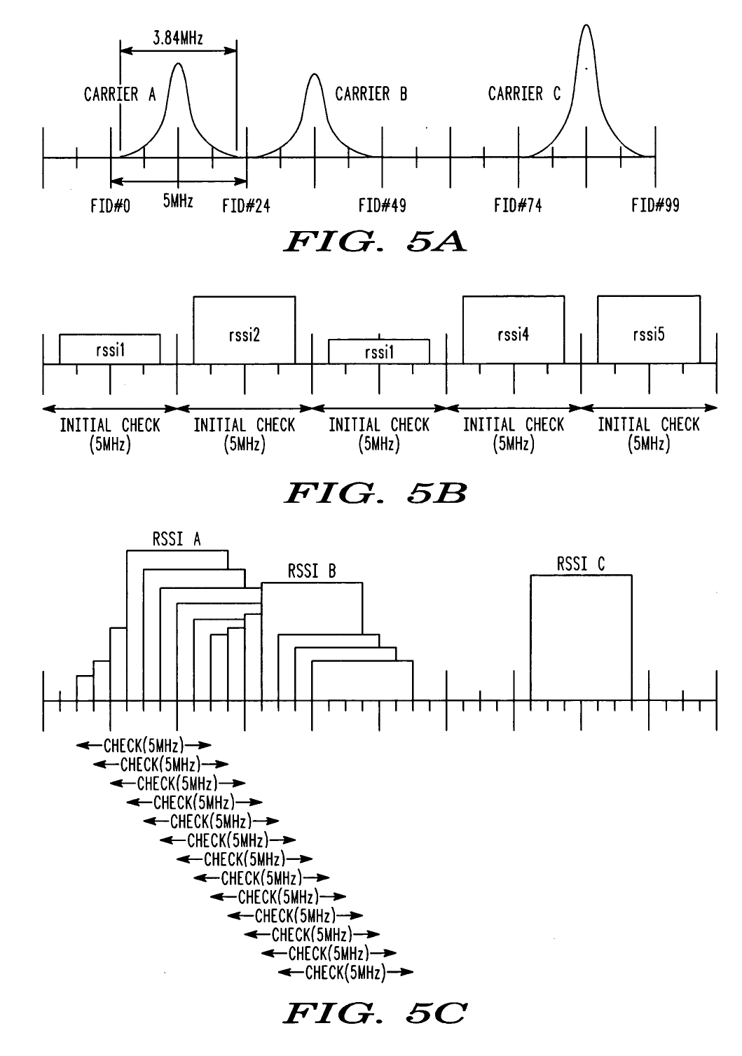

In one embodiment of the invention, the alternative processing routine accessed from step 26 may be a routine that scans all available frequencies in the environment to acquire and assign a base station frequency (i.e., step 52). However, in the presently preferred embodiment, the alternative routine, which begins at step 28, uses pre-stored frequency shift information, which may be read from a memory of the device. For example, a prestored shift value may be 1, 2 or 3 MHz. Then, at step 30, the signal strength at each of the shifted frequency values within the frequency band is measured. For example, the RSSI every 3 MHz is measured. This will be described in more detail with regard to example 3 (FIGS. 5A-5C) below. At step 32, the center frequency is estimated for each 200 kHz band for GSM and for wideband (WCDMA) every 5 MHz. Then, at step 34, if the RSSI at the center frequency is greater than a predetermined value, the frequency is assigned and the method proceeds to step 18 to perform the known channel decoding procedures. For example, the predetermined RSSI value may be −90±10 dbm for a WCDMA system. If more than one of the center frequencies is greater than the predetermined minimum value, then either the first one that is greater than the minimum value or the center frequency with the highest RSSI value may be selected. If none of the values are greater than the predetermined minimum, then execution would proceed to step 52, which is a routine for scanning all frequencies (i.e., the conventional method).

If, on the other hand, the device is powered on in a W-CDMA environment, then the method proceeds from step 24 to step 36. Step 36 checks that procedure1 is available, that is, stored in the memory. It is noted that step 36 could be eliminated and step 24 could proceed directly to step 38.

As previously discussed, W-CDMA currently defines about 300 carrier frequencies that overlap over a 60 Mhz band. Rather than scanning all of these frequencies for a base station carrier frequency, which is time consuming, the present invention scans at 5 MHz intervals. Thus, for a 60 MHz band, twelve (12) scans are performed. This will be shown in more detail when referring to the examples below. Of course, as will be understood by those of skill in the art, the scanning interval can be varied. For example, 6 scans at 10 MHz intervals could be performed over a 60 MHz band. Thus, the present invention is not to be limited to a particular scanning interval.

Thus, at step 38, scanning of the frequency band at predetermined intervals is performed. Each predetermined interval has a received signal strength, which is measured and a received signal strength indication (RSSI) is calculated for each predetermined interval at step 40. At step 42, an RSSI ratio using the RSSI measurements is calculated every 5 MHz for adjacent scanned intervals. Preferably, this calculation is performed only on adjacent intervals when both of the adjacent intervals have a RSSI value greater than a predetermined minimum value.

At step 44, the calculated RSSI ratios are shifted and added. That is, adjacent RSSI ratios are summed and shifted to a center band thereof. For 5 MHz scanned intervals, the RSSI ratios are shifted 2.5 MHZ and then summed. Where a scan and measurement at steps 38 and 42 did not detect a signal (RSSI is equal to about 0.0), then no shift and summing is done at this 5 MHz frequency band. At step 46, the summed RSSI values are compared to a predetermined minimum RSSI value and if the summed value is greater than the predetermined minimum value, at step 50 a center frequency of the summed value is estimated and this center frequency is assigned to the device, with subsequent channel decoding being performed at step 18. The predetermined minimum RSSI value may depend on the carrier. In the presently preferred embodiment, a predetermined minimum RSSI value of −90±10 dbm is used. Like step 34, if more than one of the center frequencies is greater than the predetermined minimum value, then either the first one that is greater than the minimum value or the center frequency with the highest RSSI value may be selected.

If, at step 46, none of the summed RSSI values are greater than the predetermined minimum value, then the method loops back to step 38 and repeats the process with the predetermined intervals of the scanning step being shifted by a predetermined amount, such as by 2.5 MHz. For example, in the second loop of the routine, scanning would occur every 5 MHz, but each RSSI measurement would be offset from the measurements of the prior loop by 2.5 MHz. Subsequent loops shift by different values again, e.g., 2 MHz shift. Each time the loop is performed, smaller intervals are scanned. At an intermediate step 48, prior to looping, the method checks a count value so that the loop is only performed a certain number of times. If, for instance, the loop has been performed three (3) times, then it may be more efficient to stop the looping and jump to step 52. As previously discussed, at step 52, all frequencies are scanned and RSSI measurements are made, as is conventionally done, to select and assign a communication frequency. As an alternative, the loop could be performed until it reaches a stage where all frequencies are scanned without having to jump to a separate step 52.

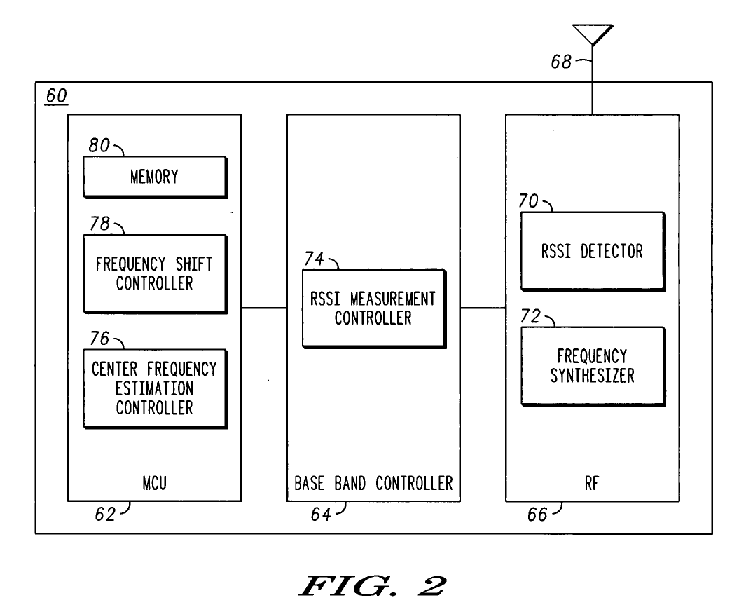

Referring now to FIG. 2, the present invention further provides a communications device 60 that executes the aforedescribed method for acquiring and assigning a base station frequency for communication between the base station and the device 60. FIG. 2 is a schematic block diagram of a portion of the communications device 60. The communications device 60 includes a microcontrol unit (MCU) 62, a base band controller 64, an RF section 66, and an antenna 68. The antenna 68 allows for the transmission and reception of wireless signals over predefined communications channels.

The antenna 68 is connected to the RF section 66. The RF section 66 includes an RSSI detector 70 and a frequency synthesizer 72. The RSSI detector 70 measures the signal strength of signals received via the antenna 68 in a known manner. The antenna 68 is coupled through a diplexer in the RF section to an analog receiver and transmit power amplifier circuitry. The antenna 68, diplexer, receiver and transmit circuitry, and RSSI detector 70 are of standard design and permit simultaneous transmission and reception through a single antenna. The antenna 68 collects transmitted RF signals and provides them through the diplexer to the analog receiver. The RF signals from the diplexer are typically in the 850 MHz frequency band, or in the 1.8 or 1.9 gigahertz frequency bands. The RF signals are down converted by the frequency synthesizer 72 to an intermediate frequency (IF). The frequency synthesizer 72 is of standard design, and permits the receiver to be tuned to any of the frequencies within the receive frequency band of the overall cellular telephone frequency band. The IF signal is then passed through a filter, such as a surface acoustic wave (SAW) bandpass filter (not shown), which may be, for example, approximately 5.0 MHz in bandwidth. The characteristics of the SAW filter are chosen to match the waveform of the signal transmitted by the cell-site, which has been direct sequence spread spectrum modulated by a positive-negative (PN) sequence clocked at a predetermined rate, typically about 4.096 MHz. The RF section 66 also performs a power control function for adjusting the transmit power of the device 60. The RF section 66 generates an analog power control signal.

The RF section 66 is connected to the base band controller 64. The base band controller 64 includes an RSSI measurement controller 74. The RSSI measurement controller 74 will measure the strength of any reception of a desired waveform. The RSSI measurement controller 74 provides a signal strength signal to the MCU 62 indicative of the strongest signals and relative time relationship. The base band controller 64 is provided with an analog to digital (A/D) converter (not shown) for converting the IF signal to a digital signal with conversion occurring at a 32,768 MHz clock rate in the preferred embodiment, which is exactly eight times the PN chip rate. The digitized signal is provided to each of two or more signal processors or data receivers, one of which is the MCU 62 and the remainder being data receivers. However, it should be understood that an inexpensive, low performance mobile device might have only a single data receiver while higher performance units may have two or more to allow for diversity reception.

The MCU 62 is preferably of a type known in the art and generally commercially available, such as a MOTOROLA M-CORE processor. The MCU 62 includes a center frequency estimation controller 76, a frequency shift controller 78 and a memory 80. The center frequency estimation controller 76 controls the shift frequency and RSSI comparison value. The frequency shift controller 78 controls how much the frequency is shifted, for example at steps 30 and 44. The memory 80 is used to store program code to control operation of the MCU 62 so that it performs the method described above and shown in FIG. 1. As will be understood by those of skill in the art, the center frequency shift controller 76 and the frequency shift controller 78 need not be specialized hardware, but can be implemented via program code executing in the memory 80 of the MCU 62.

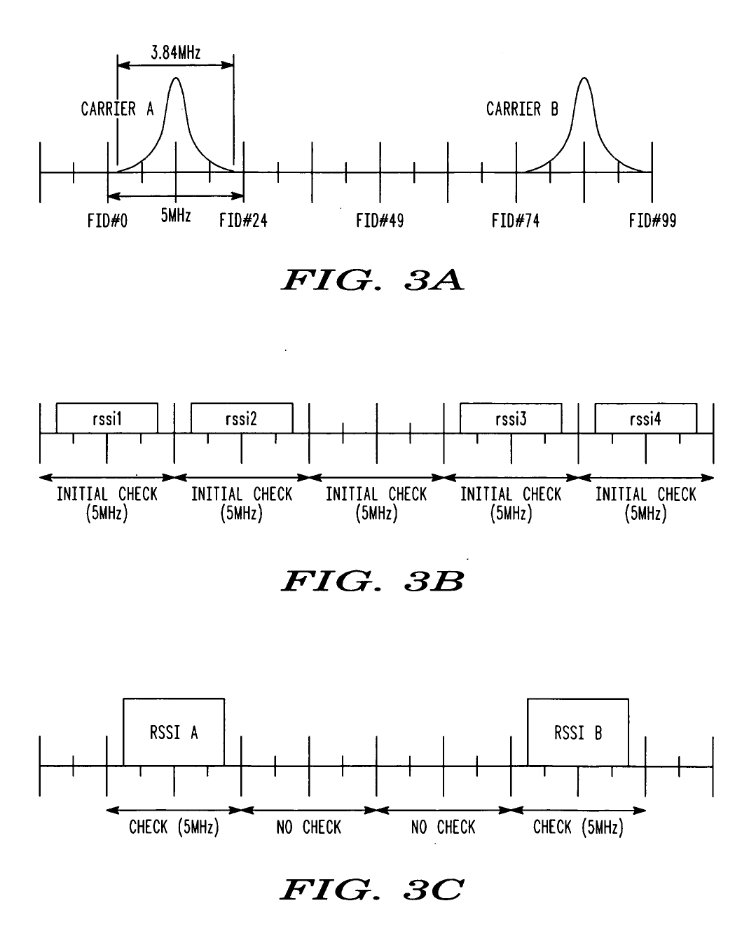

The above-described method will now be applied to some examples, shown in FIGS. 3A-3C, 4A-4C, and 5A-5C. Referring now to the first example, shown in FIGS. 3A-3C, FIG. 3A is a graph showing a frequency band having a plurality of frequency identifications (FID#0 to FID#99). The W-CDMA bandwidth is 3.84 MHz and 5 MHz including a guard band. For this example, two carriers are shown, Carrier A and Carrier B, out of a possible 300 transmitting over a 60 MHz bandwidth. For ease of example, the graph of FIG. 3A only shows up to FID#99, instead of extending out to show to FID#299. Referring also to the flow chart of FIG. 1, if a communications device is powered on in a W-CDMA environment and the device uses the search algorithm of the present invention, then FIG. 3B shows the results of measuring RSSI and calculating an RSSI ratio of steps 40 and 42. That is, scanning and measuring RSSI every 5 MHz results in RSSI measurements rssi1, rssi2, rssi3 and rssi4. Rssi1 and rssi2 are determined from Carrier A and rssi3 and rssi4 are determined from Carrier B. The RSSI detector 70 determines an active RSSI value and provides it to the MCU 62 by way of the RSSI measurement controller 74, which determines how many RSSI measurements to take. Since in FIG. 3A there was no carrier around FID#49, the corresponding RSSI value at the middle 5 MHz check has a value of zero. FIG. 3C shows the results of shifting the frequency and adding the RSSI measurements at step 44. More particularly, RSSI A is the sum of rssi1 and rssi2, while RSSI B is the sum of rssi3 and rssi4. Note that no check is performed at the two 5 MHz bands that lie between RSSI A and RSSI B because in FIG. 3A, there was no carrier detected at these two frequency bands. The algorithm of the present invention would then go on to compare the values of RSSI A and RSSI B to a predetermined minimum RSSI value and select the one that is greater than the predetermined value. If both or more than one is greater than the predetermined value, then the carrier with the highest RSSI value is selected. If the carriers have the same RSSI value, as shown in FIG. 3C, the algorithm can select either one, such as default selecting the greatest or if equal, then the first one, which would be RSSI A. Next, the center frequency of RSSI A would be determined at step 50 and then this center frequency would be assigned for channel decoding at step 18.

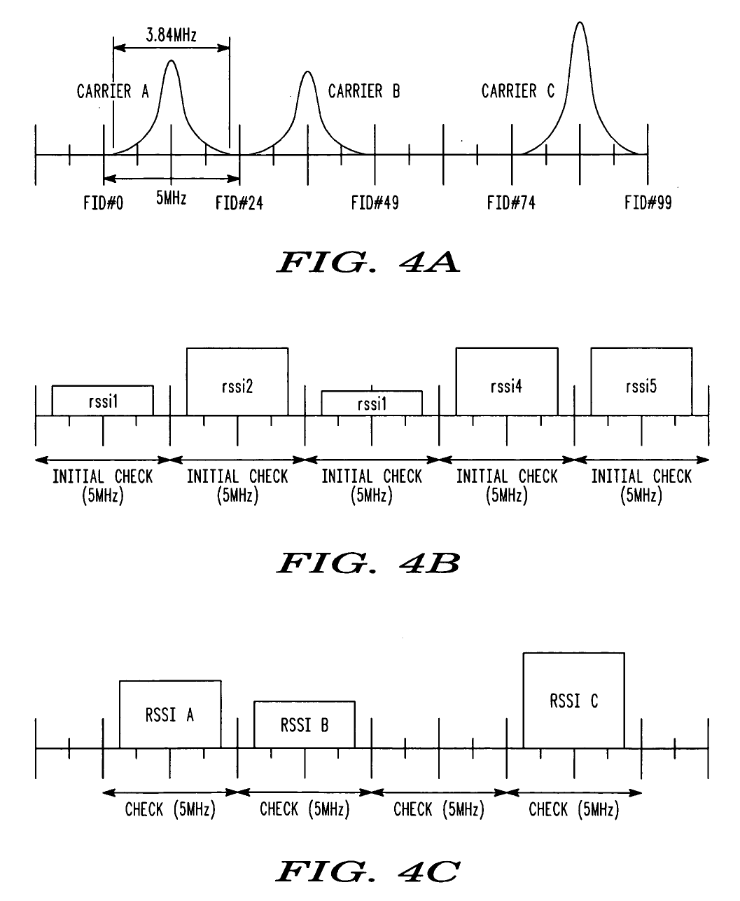

Referring now to FIGS. 4A-4C, a second example is shown. FIG. 4A, like FIG. 3A, is a graph showing a frequency band having a plurality of frequency identifications (FID#0 to FID#99). For this example, three carriers are shown, Carrier A, Carrier B, and Carrier C, having different signal strengths. FIG. 4B shows the results of measuring RSSI and calculating an RSSI ratio of steps 40 and 42. Scanning and measuring RSSI every 5 MHz results in RSSI measurements rssi1, rssi2, rssi3, rssi4 and rssi5. Rssi1 is determined from Carrier A, rssi2 is determined from Carriers A and B, rssi3 is determined from Carrier B, and rssi4 and rssi5 are determined from Carrier C. Note that although in FIG. 4A, no carrier is transmitted from the 5 MHz band between Carriers B and C, the RSSI averaging function has a value in this band. However, in FIG. 4C, we see that during the define and shift step 44, no define and shift is done in this band because there was no carrier there. Referring now to FIG. 4C, RSSI A is the sum of rssi1 and rssi2; RSSI B is the sum of rssi2 and rssi3; and RSSI C is the sum of rssi4 and rssi5. The algorithm of the present invention would then go on to compare the values of RSSI A, RSSI B, and RSSI C to the predetermined minimum RSSI value and select, in this case, RSSI C since it has the highest value (and is presumably over the minimum value). Next, the center frequency of RSSI C would be determined at step 50 and then this center frequency is assigned for channel decoding at step 18.

Referring now to FIGS. 5A-5C, a third example is shown. This example is directed to procedure2, which is accessed from step 26 and begins with step 28. FIG. 5A is a graph showing a frequency band having a plurality of frequency identifications FID#0 to FID#99, with three carriers being shown, Carrier A, Carrier B, and Carrier C, having different signal strengths. FIG. 5B shows the results of measuring RSSI at the shift frequency values (step 30). Scanning and measuring RSSI every 5 MHz results in RSSI measurements rssi1, rssi2, rssi3, rssi4 and rssi5. Rssi1 is determined from Carrier A, rssi2 is determined from Carriers A and B, rssi3 is determined from Carrier B, and rssi4 and rssi5 are determined from Carrier C. FIG. 5C shows the results of shifting the frequency and adding the RSSI measurements so that center frequency estimation can be performed at step 32. More particularly, RSSI A is the sum of rssi1 and rssi2, while RSSI B is the sum of rssi2 and rssi3, and RSSI C is the sum of rssi4 and rssi5, at different frequency shift ranges defined by the shift value. In this example, FIG. 5C shows using a smaller shift value than in the previous two examples. A smaller shift value may be desirable in more complicated areas where there are many carriers. The shift value may be set based on a number of factors, including a user's primary carrier, number of carriers in the area, etc. The algorithm of the present invention would then go on to compare the values of RSSI A, RSSI B and RSSI C, as well as the other RSSI values not labeled, to a predetermined minimum RSSI value and select one that is greater than the predetermined value. If more than one is greater than the predetermined value, then the carrier with the highest RSSI value may be selected. Next, the center frequency of RSSI A would be determined at step 32 and then this center frequency would be assigned for channel decoding at step 18.

While the invention has been described in the context of a preferred embodiment, it will be apparent to those skilled in the art that the present invention may be modified in numerous ways and may assume many embodiments other than that specifically set out and described above. For example, the search algorithm may be implemented completely in hardware, completely in software, or with various combinations thereof. Accordingly, it is intended that the appended claims cover all modifications of the invention that fall within the scope of the invention.

1. A method of searching for and assigning a base station carrier frequency to a wireless device, wherein the base station carrier frequency is located within a predetermined frequency band, the method comprising the steps of:
scanning the predetermined frequency band at predetermined intervals, each predetermined interval having a received signal strength;
measuring the received signal strength at each predetermined interval and generating a received strength signal indication (RSSI) at each predetermined interval;
calculating an RSSI ratio for adjacent scanned intervals;
comparing the calculated RSSI ratios to a predetermined RSSI value;
estimating a center frequency of at least one of the calculated RSSI ratios that is greater than the predetermined RSSI value; and
assigning the estimated center frequency to the wireless device for communications with the base station.

2. The method of searching for and assigning a base station carrier frequency to a wireless device of claim 1, wherein the predetermined frequency band is a W-CDMA frequency band.

3. The method of searching for and assigning a base station carrier frequency to a wireless device of claim 1, wherein the predetermined scanning interval is about 5 MHz.

4. The method of searching for and assigning a base station carrier frequency to a wireless device of claim 1, wherein the calculating step is performed only on adjacent intervals when both of the adjacent intervals have a RSSI value greater than a predetermined minimum value.

5. The method of searching for and assigning a base station carrier frequency to a wireless device of claim 1, wherein the scanning, measuring, calculating and comparing steps define a loop, and wherein in the comparing step, if none of the calculated RSSI ratios exceed the predetermined RSSI value, then the loop steps are performed again, with the predetermined intervals of the scanning step being adjusted so that more frequencies within the predetermined frequency band are scanned.

6. The method of searching for and assigning a base station carrier frequency to a wireless device of claim 5, wherein the loop is performed a predetermined number of times if none of the calculated RSSI ratios exceed the predetermined RSSI value.

7. The method of searching for and assigning a base station carrier frequency to a wireless device of claim 6, wherein after if the loop is performed said predetermined number of times and still none of the calculated RSSI ratios exceed the predetermined RSSI value, then the scanning step scans all of the frequencies of the predetermined frequency band and checks the RSSI at each frequency until a band having an RSSI exceeding the predetermined RSSI value is found.

8. The method of searching for and assigning a base station carrier frequency to a wireless device of claim 1, further comprising the steps of:
prior to the scanning step, determining whether base station carrier frequency data has been pre-set, including a pre-set frequency; and
based on the results of the determining step, measuring the signal strength of the pre-set frequency.

9. The method of searching for and assigning a base station carrier frequency to a wireless device of claim 1, further comprising the steps of:
prior to the scanning step, determining if an alternative carrier frequency assignment routine has been pre-stored in the wireless device; and
based on the results of the determining step, if an alternative routine has been pre-stored, executing the pre-stored frequency assignment routine.

10. The method of searching for and assigning a base station carrier frequency to a wireless device of claim 1, further comprising the steps of:
prior to scanning step, determining if the wireless device has been powered on in a W-CDMA environment, and if the environment is not a W-CDMA environment, then scanning all available frequencies in the environment to acquire and assign a base station frequency.

11. A circuit for searching for and assigning a base station carrier frequency to a wireless device, wherein the base station carrier frequency is located within a predetermined frequency band, the circuit comprising:
an RSSI detector connected to an antenna that detects a signal strength of signals received by the antenna;
an RSSI measurement controller for determining RSSI values at various frequency intervals;
a center frequency estimation controller for calculating a center frequency from the RSSI values determined by the RSSI measurement controller;
a frequency shift controller for specifying the various frequency intervals used by the RSSI measurement controller; and
a memory for storing program code that controls the RSSI measurement controller and the frequency shift controller such that RSSI ratios for adjacent scanned intervals are calculated and compared to a predetermined RSSI value, and if the RSSI ratio is greater than the predetermined RSSI value, a center frequency of said RSSI ratio is estimated and said center frequency is assigned to the wireless device for communications with the base station.

12. The circuit of claim 11, wherein the predetermined frequency band is a W-CDMA frequency band.

13. The circuit of claim 11, wherein the predetermined scanning interval is about 5 MHz.
